(19) United States
(12) Patent Application Publication
(10) Pub. No.: US 2024/0118407 A1
(43) Pub. Date: Apr. 11, 2024

(54) SENSOR, ESTIMATION METHOD, AND SENSOR SYSTEM

(71) Applicant: Panasonic Intellectual Property Management Co., Ltd., Osaka (JP)

(72) Inventors: Shoichi IIZUKA, Osaka (JP); Takeshi NAKAYAMA, Hyogo (JP); Naoki HONMA, Iwate (JP); Nobuyuki SHIRAKI, Osaka (JP); Kentaro MURATA, Iwate (JP)

(73) Assignee: Panasonic Intellectual Property Management Co., Ltd., Osaka (JP)

(21) Appl. No.: 18/268,498

(22) PCT Filed: Dec. 22, 2021
(86) PCT No.: PCT/JP2021/047663

§ 371 Date: Jun. 20, 2023

(30) Foreign Application Priority Data
Dec. 25, 2020 (JP) 2020-217847

(51) Int. Cl. G01S 13/46; G01S 7/02

(52) U.S. Cl. CPC G01S 13/46; G01S 7/02

(57) ABSTRACT

A sensor receives M reception signals including reflection signals reflected by a living body; extracts a living-body component transfer function matrix from first complex transfer functions and second complex transfer functions, the first complex transfer functions being obtained by recording an M×N complex transfer function matrix including complex transfer functions in time series, from M reception signals, the complex transfer functions each indicating characteristics of propagation between a corresponding one of transmission antenna elements and a corresponding one of reception antenna elements, the second complex transfer functions being obtained by estimating and recording M×N complex transfer functions in a second period, and outputting a position at which a spectrum function indicating a likelihood that a living body is present indicates a local maximum value, using a correlation matrix based on the living-body component complex transfer function matrix and a steering vector corresponding to each of measurement-target regions.

### TECHNICAL FIELD

The present disclosure relates to a sensor, an estimation method, and a sensor system for estimating positions of a living body using radio signals.

### BACKGROUND ART

Techniques for detecting detection targets using signals that are transmitted wirelessly have been developed (for example, see Patent Literature 1).

Patent Literature 1 discloses that it is possible to detect the number of detection target humans and the positions of the humans by analyzing eigenvalues of components including doppler shifts using Fourier transform on signals received wirelessly.

### CITATION LIST

### Patent Literature

[PTL 1] Japanese Unexamined Patent Application Publication No. 2015-117972
[PTL 2] Japanese Unexamined Patent Application Publication No. 2014-228291
[PTL 3] Japanese Patent No. 5047002
[PTL 4] Japanese Patent No. 5025170

### SUMMARY OF INVENTION

### Technical Problem

However, the technique disclosed in Patent Literature 1 entails a problem that a signal from a detection target that lasts several seconds corresponding to the cycle of respiration needs to be observed, which causes a delay until the result of estimating the position of the detection target is obtained.

The present disclosure has been conceived in view of the above circumstances, and has an object to provide a sensor, etc., for estimating the positions of a living body using radio signals with low delay.

### Solution to Problem

In order to achieve the above object, a sensor according to an aspect of the present disclosure is a sensor which detects a position of a living body, and the sensor includes: a transmission antenna which includes N transmission antenna elements, N being a natural number of two or more; a reception antenna which includes M reception antenna elements, M being a natural number of two or more; a transmitter which transmits transmission signals to a measurement target region using the N transmission antenna elements; a receiver which receives M reception signals which have been received respectively by the M reception antenna elements and include reflection signals resulting from the transmission signals transmitted respectively from the N transmission antenna elements being reflected by the living body; a first complex transfer function calculator which calculates first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements; a second complex transfer function calculator which calculates second complex transfer functions during a second period that is not included in the first period by performing linear prediction onto the first complex transfer functions to estimate M×N complex transfer functions in time series; a living-body component extractor which extracts, using the first complex transfer functions and the second complex transfer functions, a living-body component complex transfer function matrix belonging to a predetermined frequency range corresponding to components affected by one or more vital activities that include at least one of respiration, a heartbeat, or motion of the living body; a correlation matrix calculator which generates a living-body component complex transfer function vector by re-arranging elements of the living-body component complex transfer function matrix, and calculates a correlation matrix in a frequency direction of the living-body component complex transfer function vector obtained; a steering vector calculator which calculates a steering vector constituted by elements corresponding respectively to positions of a plurality of regions into which the measurement target region is divided; a spectrum function calculator which calculates a spectrum function indicating a likelihood that the living body is present, using the correlation matrix and the steering vector; and a position measurer which outputs a position at which the spectrum function indicates a local maximum value as a position of the living body.

Furthermore, a sensor according to another aspect of the present disclosure is a sensor which detects a position of a living body, and the sensor includes: a transmission antenna which includes N transmission antenna elements, N being a natural number of two or more; a reception antenna which includes M reception antenna elements, M being a natural number of two or more; a transmitter which transmits transmission signals to a measurement target region using the N transmission antenna elements; a receiver which receives M reception signals which have been received respectively by the M reception antenna elements and include reflection signals resulting from the transmission signals transmitted respectively from the N transmission antenna elements being reflected by the living body; a first complex transfer function calculator which calculates first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements; a second complex transfer function calculator which calculates second complex transfer functions during a second period that is not included in the first period by performing linear prediction onto the first complex transfer functions to estimate M×N complex transfer functions in time series; a complex transfer function generator which generates, from the first complex transfer functions and the second complex transfer functions, S third complex transfer functions in mutually different S periods, S being a natural number of two or more; a living-body component extractor which extracts, using the S third complex transfer functions, a living-body component complex transfer function matrix belonging to a predetermined frequency range corresponding to components affected by one or more vital activities that include at least one of respiration, a heartbeat, or motion of the living body; a correlation matrix calculator which generates a living-body component complex transfer function vector by re-arranging elements of the living-body component complex transfer function matrix, and calculates a correlation matrix in a frequency direction of the living-body component complex transfer function vector obtained; a steering vector calculator which calculates S×K extended steering vectors by calculating S steering vectors constituted by elements corresponding respectively to positions of a plurality of regions into which the measurement target region is divided and performing mapping onto each of the S steering vectors, the mapping using a corresponding one of mapping variables, the corresponding one of mapping variables being one of K possible values, K being a natural number of two or more; a spectrum function calculator which calculates, using the correlation matrix and the S×K extended steering vectors, S×K extended spectrum functions indicating a likelihood that the living body is present using, as variables, the positions of the plurality of regions and the mapping variables; an individual spectrum combiner which calculates, for each of the K mapping variables, a corresponding one of K combined spectrum functions by combining S extended spectrum functions calculated using the mapping variables as variables among the S×K extended spectrum functions; and a position measurer which outputs a position at which one of the K combined spectrum functions indicates a local maximum value, and outputs a mapping variable that indicates the local maximum value as a mapping variable of the living body.

Furthermore, an estimation method according to an aspect of the present disclosure is an estimation method that is performed by a sensor including: N transmission antenna elements and M reception antenna elements, N and M each being a natural number of two or more. The estimation method includes: transmitting transmission signals to a measurement target region using the N transmission antenna elements; receiving M reception signals which have been received respectively by the M reception antenna elements and include reflection signals resulting from the transmission signals transmitted respectively from the N transmission antenna elements being reflected by the living body; calculating first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements; calculating second complex transfer functions during a second period that is not included in the first period by performing linear prediction onto the first complex transfer functions to estimate M×N complex transfer functions in time series; extracting, using the first complex transfer functions and the second complex transfer functions, a living-body component complex transfer function matrix belonging to a predetermined frequency range corresponding to components affected by one or more vital activities that include at least one of respiration, a heartbeat, or motion of the living body; generating a living-body component complex transfer function vector by re-arranging elements of the living-body component complex transfer function matrix, and calculating a correlation matrix in a frequency direction of the living-body component complex transfer function vector obtained; calculating a steering vector constituted by elements corresponding respectively to positions of a plurality of regions into which the measurement target region is divided; calculating a spectrum function indicating a likelihood that the living body is present, using the correlation matrix and the steering vector; and outputting a position at which the spectrum function indicates a local maximum value as a position of the living body.

Furthermore, an estimation method according to another aspect of the present disclosure is an estimation method that is performed by a sensor including: N transmission antenna elements and M reception antenna elements, N and M each being a natural number of two or more. The estimation method includes: transmitting transmission signals to a measurement target region using the N transmission antenna elements; receiving M reception signals which have been received respectively by the M reception antenna elements and include reflection signals resulting from the transmission signals transmitted respectively from the N transmission antenna elements being reflected by the living body; calculating first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements; calculating second complex transfer functions during a second period that is not included in the first period by performing linear prediction onto the first complex transfer functions to estimate M×N complex transfer functions in time series; generating, from the first complex transfer functions and the second complex transfer functions, S third complex transfer functions in mutually different S periods, S being a natural number of two or more; extracting, using the S third complex transfer functions, a living-body component complex transfer function matrix belonging to a predetermined frequency range corresponding to components affected by one or more vital activities that include at least one of respiration, a heartbeat, or motion of the living body; generating a living-body component complex transfer function vector by re-arranging elements of the living-body component complex transfer function matrix, and calculating a correlation matrix in a frequency direction of the living-body component complex transfer function vector obtained; calculating S×K extended steering vectors by calculating S steering vectors constituted by elements corresponding respectively to positions of a plurality of regions into which the measurement target region is divided and performing mapping onto each of the S steering vectors, the mapping using a corresponding one of mapping variables, the corresponding one of mapping variables being one of K possible values, K being a natural number of two or more; calculating, using the correlation matrix and the S×K extended steering vectors, S×K extended spectrum functions indicating a likelihood that the living body is present using, as variables, the positions of the plurality of regions and the mapping variables; calculating, for each of the K mapping variables, a corresponding one of K combined spectrum functions by combining S extended spectrum functions calculated using the mapping variables as variables among the S×K extended spectrum functions; and outputting a position at which one of the K combined spectrum functions indicates a local maximum value, and outputting a mapping variable that indicates the local maximum value as a mapping variable of the living body.

Furthermore, a sensor system according to an aspect of the present disclosure is a sensor system including: a sensor which detects current positions of a living body; and a server which sequentially obtains the current positions detected by the sensor from the sensor via a network, and accumulates the current positions obtained sequentially, wherein the sensor includes: a transmission antenna which includes N transmission antenna elements, N being a natural number of two or more; a reception antenna which includes M reception antenna elements, M being a natural number of two or more; a transmitter which transmits transmission signals to a measurement target region using the N transmission antenna elements; a receiver which receives M reception signals which have been received respectively by the M reception antenna elements and include reflection signals resulting from the transmission signals transmitted respectively from the N transmission antenna elements being reflected by the living body; a first complex transfer function calculator which calculates first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements; a second complex transfer function calculator which calculates second complex transfer functions during a second period that is not included in the first period by performing linear prediction onto the first complex transfer functions to estimate M×N complex transfer functions in time series; a living-body component extractor which extracts, using the first complex transfer functions and the second complex transfer functions, a living-body component complex transfer function matrix belonging to a predetermined frequency range corresponding to components affected by one or more vital activities that include at least one of respiration, a heartbeat, or motion of the living body; a correlation matrix calculator which generates a living-body component complex transfer function vector by re-arranging elements of the living-body component complex transfer function matrix, and calculates a correlation matrix in a frequency direction of the living-body component complex transfer function vector obtained; a steering vector calculator which calculates a steering vector constituted by elements corresponding respectively to positions of a plurality of regions into which the measurement target region is divided; a spectrum function calculator which calculates a spectrum function indicating a likelihood that the living body is present, using the correlation matrix and the steering vector; and a position measurer which outputs a position at which the spectrum function indicates a local maximum value as a position of the living body.

Furthermore, a sensor system according to another aspect of the present disclosure is a sensor system including: a sensor which detects current positions of a living body; and a server which sequentially obtains the current positions detected by the sensor from the sensor via a network, and accumulates the current positions obtained sequentially, wherein the sensor is a sensor which identifies the current positions of the living body and includes: a transmission antenna which includes N transmission antenna elements, N being a natural number of two or more; a reception antenna which includes M reception antenna elements, M being a natural number of two or more; a transmitter which transmits transmission signals to a measurement target region using the N transmission antenna elements; a receiver which receives M reception signals which have been received respectively by the M reception antenna elements and include reflection signals resulting from the transmission signals transmitted respectively from the N transmission antenna elements being reflected by the living body; a first complex transfer function calculator which calculates first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements; a second complex transfer function calculator which calculates second complex transfer functions during a second period that is not included in the first period by performing linear prediction onto the first complex transfer functions to estimate M×N complex transfer functions in time series; a complex transfer function generator which generates, from the first complex transfer functions and the second complex transfer functions, S third complex transfer functions in mutually different S periods, S being a natural number of two or more; a living-body component extractor which extracts, using the S third complex transfer functions, a living-body component complex transfer function matrix belonging to a predetermined frequency range corresponding to components affected by one or more vital activities that include at least one of respiration, a heartbeat, or motion of the living body; a correlation matrix calculator which generates a living-body component complex transfer function vector by re-arranging elements of the living-body component complex transfer function matrix, and calculates a correlation matrix in a frequency direction of the living-body component complex transfer function vector obtained; a steering vector calculator which calculates S×K extended steering vectors by calculating S steering vectors constituted by elements corresponding respectively to positions of a plurality of regions into which the measurement target region is divided and performing mapping onto each of the S steering vectors, the mapping using a corresponding one of mapping variables, the corresponding one of mapping variables being one of K possible values, K being a natural number of two or more; a spectrum function calculator which calculates, using the correlation matrix and the S×K extended steering vectors, S×K extended spectrum functions indicating a likelihood that the living body is present using, as variables, the positions of the plurality of regions and the mapping variables; an individual spectrum combiner which calculates, for each of the K mapping variables, a corresponding one of K combined spectrum functions by combining S extended spectrum functions calculated using the mapping variables as variables among the S×K extended spectrum functions; and a position measurer which outputs a position at which one of the K combined spectrum functions indicates a local maximum value, and outputs a mapping variable that indicates the local maximum value as a mapping variable of the living body.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

### Advantageous Effects of Invention

The sensor according to the present disclosure makes it possible to estimate the positions of a living body using radio signals with low delay.

### BRIEF DESCRIPTION OF DRAWINGS

FIG. 1 is a block diagram illustrating a configuration of a sensor in Embodiment 1.

FIG. 2 is a block diagram illustrating a configuration of a spectrum calculator in Embodiment 1.

FIG. 3 is a diagram conceptually illustrating conceptually illustrating a state in which signal waves are transmitted in the sensor illustrated in FIG. 1.

FIG. 4 is a diagram schematically indicating calculation processes in a second complex transfer function calculator in Embodiment 1.

FIG. 5 is a diagram conceptually illustrating a region that is an estimation target by an estimation device illustrated in FIG. 1.

FIG. 6 is a flow chart indicating estimation processing by the sensor in Embodiment 1.

FIG. 7 is a block diagram illustrating a configuration of a sensor in each of Embodiments 2 and 3.

FIG. 8 is a block diagram illustrating a configuration of a spectrum calculator in each of Embodiments 2 and 3.

FIG. 9 is a flow chart indicating estimation processing by the sensor in Embodiment 2.

FIG. 10 is a diagram schematically illustrating time-series movements of a detection target living body in Embodiment 3.

FIG. 11 is a diagram schematically illustrating a state in which a steering vector is shifted in each of velocities in Embodiment 3.

### DESCRIPTION OF EMBODIMENTS

### (Underlying Knowledge Forming Basis of the Present Disclosure)

Methods using radio signals have been considered as methods for detecting, for example, the positions of humans. For example, Patent Literatures 1 and 2 each disclose that radio signals are transmitted in a predetermined region, the radio signals reflected by a detection target are received by a plurality of antennas, and that a complex transfer function between the transmission and reception antennas are estimated. The complex transfer function is a function of a complex number indicating the relation between input and output. Here, the complex transfer function indicates propagation characteristics between the transmission and reception antennas. The number of elements of the complex transfer function equals to a product of the number of transmission antennas and the number of reception antennas.

Patent Literature 1 further discloses that it is possible to detect the position and a state of a human who is a detection target by analyzing components including doppler shifts using Fourier transform. More specifically, temporal changes of the elements of the complex transfer function are recorded, and the temporal waveforms are Fourier-transformed. The vital activities such as respiration, a heartbeat, or the like of a living body such as a human provides slight doppler effects on the reflected waves. Accordingly, the components including the doppler shifts are affected by the vital activities of the human. On the other hand, the components that do not include doppler shifts are not affected by the vital activities of the human, that is, correspond to reflected waves from a fixed object or direct waves between the transmission and reception antennas. In other words, Patent Literature 1 discloses that it is possible to detect the position or state of the human who is the detection target using the components included in a predetermined frequency range in a Fourier-transformed waveform.

Patent Literature 2 discloses a method of recording temporal changes in the elements of a complex transfer function, and extracting the components including slight doppler shifts affected by a living body by analyzing difference information about the temporal changes. In other words, Patent Literature 2 discloses that it is possible to detect the position or the state of the human who is the detection target using the difference information.

However, the methods in Patent Literatures 1 and 2 each require that radio signals be observed over a period corresponding to the cycle of a vital activity that is for example respiration or a heartbeat of the living body which is the detection target. The cycle corresponds to a three to five second period. Furthermore in consideration of calculation time, the methods in Patent Literatures 1 and 2 each inevitably causes delay time over five seconds from when the position and posture of the living body changed.

The methods in Patent Literatures 1 and 2 each further entails a problem that it is impossible to identify the position of the target when the position of the target has widely shifted. Specifically, when the living body which is the detection target has moved during the observation period of radio signals, it is impossible to detect the position on the route along which the living body which is the detection target has moved. This makes it difficult to lengthen the measurement period for improving the SN ratio of each signal, which hampers increase in accuracy.

In view of this, the Inventors have invented the sensor which is capable of tracking the positions of a living body which is the detection target even when the living body moves during the observation period of radio signals with short delay time.

A sensor according to an aspect of the present disclosure is a sensor which detects a position of a living body, and the sensor includes: a transmission antenna which includes N transmission antenna elements, N being a natural number of two or more; a reception antenna which includes M reception antenna elements, M being a natural number of two or more; a transmitter which transmits transmission signals to a measurement target region using the N transmission antenna elements; a receiver which receives M reception signals which have been received respectively by the M reception antenna elements and include reflection signals resulting from the transmission signals transmitted respectively from the N transmission antenna elements being reflected by the living body; a first complex transfer function calculator which calculates first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements; a second complex transfer function calculator which calculates second complex transfer functions during a second period that is not included in the first period by performing linear prediction onto the first complex transfer functions to estimate M×N complex transfer functions in time series; a living-body component extractor which extracts, using the first complex transfer functions and the second complex transfer functions, a living-body component complex transfer function matrix belonging to a predetermined frequency range corresponding to components affected by one or more vital activities that include at least one of respiration, a heartbeat, or motion of the living body; a correlation matrix calculator which generates a living-body component complex transfer function vector by re-arranging elements of the living-body component complex transfer function matrix, and calculates a correlation matrix in a frequency direction of the living-body component complex transfer function vector obtained; a steering vector calculator which calculates a steering vector constituted by elements corresponding respectively to positions of a plurality of regions into which the measurement target region is divided; a spectrum function calculator which calculates a spectrum function indicating a likelihood that the living body is present, using the correlation matrix and the steering vector; and a position measurer which outputs a position at which the spectrum function indicates a local maximum value as a position of the living body.

With this, the position of the living body which is present in the measurement target region is estimated using not only the first complex transfer functions obtained through observation in the first period but also the second complex transfer functions in the second period different from the first period estimated using the first complex transfer functions. For this reason, it is possible to shorten the actual observation period by the time corresponding to the second period, and to estimate the position of the living body with short delay time. Furthermore, even when it is impossible to sufficiently separate noise and living body components by eigenvalue decomposition because of insufficient observation time of the first complex transfer functions, additional use of information about second complex transfer functions calculated through linear prediction makes it possible to sufficiently separate the noise and the living body components by eigenvalue decomposition, thereby enabling estimation of the position of the living body with high accuracy.

Furthermore, a sensor according to another aspect of the present disclosure is a sensor which detects a position of a living body, and the sensor includes: a transmission antenna which includes N transmission antenna elements, N being a natural number of two or more; a reception antenna which includes M reception antenna elements, M being a natural number of two or more; a transmitter which transmits transmission signals to a measurement target region using the N transmission antenna elements; a receiver which receives M reception signals which have been received respectively by the M reception antenna elements and include reflection signals resulting from the transmission signals transmitted respectively from the N transmission antenna elements being reflected by the living body; a first complex transfer function calculator which calculates first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements; a second complex transfer function calculator which calculates second complex transfer functions during a second period that is not included in the first period by performing linear prediction onto the first complex transfer functions to estimate M×N complex transfer functions in time series; a complex transfer function generator which generates, from the first complex transfer functions and the second complex transfer functions, S third complex transfer functions in mutually different S periods, S being a natural number of two or more; a living-body component extractor which extracts, using the S third complex transfer functions, a living-body component complex transfer function matrix belonging to a predetermined frequency range corresponding to components affected by one or more vital activities that include at least one of respiration, a heartbeat, or motion of the living body; a correlation matrix calculator which generates a living-body component complex transfer function vector by re-arranging elements of the living-body component complex transfer function matrix, and calculates a correlation matrix in a frequency direction of the living-body component complex transfer function vector obtained; a steering vector calculator which calculates S×K extended steering vectors by calculating S steering vectors constituted by elements corresponding respectively to positions of a plurality of regions into which the measurement target region is divided and performing mapping onto each of the S steering vectors, the mapping using a corresponding one of mapping variables, the corresponding one of mapping variables being one of K possible values, K being a natural number of two or more; a spectrum function calculator which calculates, using the correlation matrix and the S×K extended steering vectors, S×K extended spectrum functions indicating a likelihood that the living body is present using, as variables, the positions of the plurality of regions and the mapping variables; an individual spectrum combiner which calculates, for each of the K mapping variables, a corresponding one of K combined spectrum functions by combining S extended spectrum functions calculated using the mapping variables as variables among the S×K extended spectrum functions; and a position measurer which outputs a position at which one of the K combined spectrum functions indicates a local maximum value, and outputs a mapping variable that indicates the local maximum value as a mapping variable of the living body.

With this, the S third complex transfer functions at the S positions to which the living body has moved are generated using the radio signals, and the S positions of the living body present in the measurement target region assuming that the living body moves with constant mapping variables are estimated using the respective third complex transfer functions. For this reason, it is possible to track the positions of the living body even when the living body is moving. Furthermore, according to sensor 1A in the present embodiment, even when it is impossible to sufficiently separate noise and living body components by eigenvalue decomposition because of insufficient observation time of the first complex transfer functions, additional use of information about second complex transfer functions calculated through linear prediction makes it possible to sufficiently separate the noise and the living body components by eigenvalue decomposition, thereby enabling estimation of the position of the living body with high accuracy.

In addition, the mapping variables may be discrete K velocities.

For this reason, it is possible to narrow parameters of combined spectrum functions for which local maximum values need to be searched out down to positions and velocities, which makes it possible to reduce the amount of calculation and estimate the positions of the living body with shorter delay.

In addition, a length of the first period and a length of the second period may be equal to each other.

For this reason, it is easily possible to estimate the position that is close to the position of the living body at a current point of time.

In addition, a total length of the first period and the second period may be set to a predetermined length according to a type of a vital activity that is a measurement target among the one or more vital activities, and the predetermined length may be a length longer than or equal to a cycle of the vital activity that is the measurement target.

In addition, the second period may be a future period after the first period.

In addition, the spectrum function calculator may calculate a spectrum according to a MUltiple SIgnal Classification (MUSIC) method.

In addition, the second complex transfer function calculator may perform linear prediction using an autoregressive (AR) model.

Furthermore, an estimation method according to an aspect of the present disclosure is an estimation method that is performed by a sensor including: N transmission antenna elements and M reception antenna elements, N and M each being a natural number of two or more. The estimation method includes: transmitting transmission signals to a measurement target region using the N transmission antenna elements; receiving M reception signals which have been received respectively by the M reception antenna elements and include reflection signals resulting from the transmission signals transmitted respectively from the N transmission antenna elements being reflected by the living body; calculating first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements; calculating second complex transfer functions during a second period that is not included in the first period by performing linear prediction onto the first complex transfer functions to estimate M×N complex transfer functions in time series; extracting, using the first complex transfer functions and the second complex transfer functions, a living-body component complex transfer function matrix belonging to a predetermined frequency range corresponding to components affected by one or more vital activities that include at least one of respiration, a heartbeat, or motion of the living body; generating a living-body component complex transfer function vector by re-arranging elements of the living-body component complex transfer function matrix, and calculating a correlation matrix in a frequency direction of the living-body component complex transfer function vector obtained; calculating a steering vector constituted by elements corresponding respectively to positions of a plurality of regions into which the measurement target region is divided; calculating a spectrum function indicating a likelihood that the living body is present, using the correlation matrix and the steering vector; and outputting a position at which the spectrum function indicates a local maximum value as a position of the living body.

With this, the position of the living body which is present in the measurement target region is estimated using not only the first complex transfer functions obtained through observation in the first period but also the second complex transfer functions in the second period different from the first period estimated using the first complex transfer functions. For this reason, it is possible to shorten the actual observation period by the time corresponding to the second period, and to estimate the position of the living body with short delay time. Furthermore, even when it is impossible to sufficiently separate noise and living body components by eigenvalue decomposition because of insufficient observation time of the first complex transfer functions, additional use of information about second complex transfer functions calculated through linear prediction makes it possible to sufficiently separate the noise and the living body components by eigenvalue decomposition, thereby enabling estimation of the position of the living body with high accuracy.

Furthermore, an estimation method according to another aspect of the present disclosure is an estimation method that is performed by a sensor including: N transmission antenna elements and M reception antenna elements, N and M each being a natural number of two or more. The estimation method includes: transmitting transmission signals to a measurement target region using the N transmission antenna elements; receiving M reception signals which have been received respectively by the M reception antenna elements and include reflection signals resulting from the transmission signals transmitted respectively from the N transmission antenna elements being reflected by the living body; calculating first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements; calculating second complex transfer functions during a second period that is not included in the first period by performing linear prediction onto the first complex transfer functions to estimate M×N complex transfer functions in time series; generating, from the first complex transfer functions and the second complex transfer functions, S third complex transfer functions in mutually different S periods, S being a natural number of two or more; extracting, using the S third complex transfer functions, a living-body component complex transfer function matrix belonging to a predetermined frequency range corresponding to components affected by one or more vital activities that include at least one of respiration, a heartbeat, or motion of the living body; generating a living-body component complex transfer function vector by re-arranging elements of the living-body component complex transfer function matrix, and calculating a correlation matrix in a frequency direction of the living-body component complex transfer function vector obtained; calculating S×K extended steering vectors by calculating S steering vectors constituted by elements corresponding respectively to positions of a plurality of regions into which the measurement target region is divided and performing mapping onto each of the S steering vectors, the mapping using a corresponding one of mapping variables, the corresponding one of mapping variables being one of K possible values, K being a natural number of two or more; calculating, using the correlation matrix and the S×K extended steering vectors, S×K extended spectrum functions indicating a likelihood that the living body is present using, as variables, the positions of the plurality of regions and the mapping variables; calculating, for each of the K mapping variables, a corresponding one of K combined spectrum functions by combining S extended spectrum functions calculated using the mapping variables as variables among the S×K extended spectrum functions; and outputting a position at which one of the K combined spectrum functions indicates a local maximum value, and outputting a mapping variable that indicates the local maximum value as a mapping variable of the living body.

With this, the S third complex transfer functions at the S positions to which the living body has moved are generated using the radio signals, and the S positions of the living body present in the measurement target region assuming that the living body moves with constant mapping variables are estimated. For this reason, it is possible to track the positions of the living body even when the living body is moving. Furthermore, according to sensor 1A in the present embodiment, even when it is impossible to sufficiently separate noise and living body components by eigenvalue decomposition because of insufficient observation time of the first complex transfer functions, additional use of information about second complex transfer functions calculated through linear prediction makes it possible to sufficiently separate the noise and the living body components by eigenvalue decomposition, thereby enabling estimation of the position of the living body with high accuracy.

Furthermore, a sensor system according to an aspect of the present disclosure is a sensor system including: a sensor which detects current positions of a living body; and a server which sequentially obtains the current positions detected by the sensor from the sensor via a network, and accumulates the current positions obtained sequentially, wherein the sensor includes: a transmission antenna which includes N transmission antenna elements, N being a natural number of two or more; a reception antenna which includes M reception antenna elements, M being a natural number of two or more; a transmitter which transmits transmission signals to a measurement target region using the N transmission antenna elements; a receiver which receives M reception signals which have been received respectively by the M reception antenna elements and include reflection signals resulting from the transmission signals transmitted respectively from the N transmission antenna elements being reflected by the living body; a first complex transfer function calculator which calculates first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements; a second complex transfer function calculator which calculates second complex transfer functions during a second period that is not included in the first period by performing linear prediction onto the first complex transfer functions to estimate M×N complex transfer functions in time series; a living-body component extractor which extracts, using the first complex transfer functions and the second complex transfer functions, a living-body component complex transfer function matrix belonging to a predetermined frequency range corresponding to components affected by one or more vital activities that include at least one of respiration, a heartbeat, or motion of the living body; a correlation matrix calculator which generates a living-body component complex transfer function vector by re-arranging elements of the living-body component complex transfer function matrix, and calculates a correlation matrix in a frequency direction of the living-body component complex transfer function vector obtained; a steering vector calculator which calculates a steering vector constituted by elements corresponding respectively to positions of a plurality of regions into which the measurement target region is divided; a spectrum function calculator which calculates a spectrum function indicating a likelihood that the living body is present, using the correlation matrix and the steering vector; and a position measurer which outputs a position at which the spectrum function indicates a local maximum value as a position of the living body.

With this, the position of the living body which is present in the measurement target region is estimated using not only the first complex transfer functions obtained through observation in the first period but also the second complex transfer functions in the second period different from the first period estimated using the first complex transfer functions. For this reason, it is possible to shorten the actual observation period by the time corresponding to the second period, and to estimate the position of the living body with short delay time. Furthermore, even when it is impossible to sufficiently separate noise and living body components by eigenvalue decomposition because of insufficient observation time of the first complex transfer functions, additional use of information about second complex transfer functions calculated through linear prediction makes it possible to sufficiently separate the noise and the living body components by eigenvalue decomposition, thereby enabling estimation of the position of the living body with high accuracy.

Furthermore, a sensor system according to another aspect of the present disclosure is a sensor system including: a sensor which detects current positions of a living body; and a server which sequentially obtains the current positions detected by the sensor from the sensor via a network, and accumulates the current positions obtained sequentially, wherein the sensor is a sensor which identifies the current positions of the living body and includes: a transmission antenna which includes N transmission antenna elements, N being a natural number of two or more; a reception antenna which includes M reception antenna elements, M being a natural number of two or more; a transmitter which transmits transmission signals to a measurement target region using the N transmission antenna elements; a receiver which receives M reception signals which have been received respectively by the M reception antenna elements and include reflection signals resulting from the transmission signals transmitted respectively from the N transmission antenna elements being reflected by the living body; a first complex transfer function calculator which calculates first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements; a second complex transfer function calculator which calculates second complex transfer functions during a second period that is not included in the first period by performing linear prediction onto the first complex transfer functions to estimate M×N complex transfer functions in time series; a complex transfer function generator which generates, from the first complex transfer functions and the second complex transfer functions, S third complex transfer functions in mutually different S periods, S being a natural number of two or more; a living-body component extractor which extracts, using the S third complex transfer functions, a living-body component complex transfer function matrix belonging to a predetermined frequency range corresponding to components affected by one or more vital activities that include at least one of respiration, a heartbeat, or motion of the living body; a correlation matrix calculator which generates a living-body component complex transfer function vector by re-arranging elements of the living-body component complex transfer function matrix, and calculates a correlation matrix in a frequency direction of the living-body component complex transfer function vector obtained; a steering vector calculator which calculates S×K extended steering vectors by calculating S steering vectors constituted by elements corresponding respectively to positions of a plurality of regions into which the measurement target region is divided and performing mapping onto each of the S steering vectors, the mapping using a corresponding one of mapping variables, the corresponding one of mapping variables being one of K possible values, K being a natural number of two or more; a spectrum function calculator which calculates, using the correlation matrix and the S×K extended steering vectors, S×K extended spectrum functions indicating a likelihood that the living body is present using, as variables, the positions of the plurality of regions and the mapping variables; an individual spectrum combiner which calculates, for each of the K mapping variables, a corresponding one of K combined spectrum functions by combining S extended spectrum functions calculated using the mapping variables as variables among the S×K extended spectrum functions; and a position measurer which outputs a position at which one of the K combined spectrum functions indicates a local maximum value, and outputs a mapping variable that indicates the local maximum value as a mapping variable of the living body.

With this, the S third complex transfer functions at the S positions to which the living body has moved are generated using the radio signals, and the S positions of the living body present in the measurement target region assuming that the living body moves with constant mapping variables are estimated using the third complex transfer functions. For this reason, it is possible to track the positions of the living body even when the living body is moving. Furthermore, according to sensor 1A in the present embodiment, even when it is impossible to sufficiently separate noise and living body components by eigenvalue decomposition because of insufficient observation time of the first complex transfer functions, additional use of information about second complex transfer functions calculated through linear prediction makes it possible to sufficiently separate the noise and the living body components by eigenvalue decomposition, thereby enabling estimation of the position of the living body with high accuracy.

It is to be noted that the present disclosure can be implemented not only as a device but also as an integrated circuit including the processing units of such a device, as a method including the steps corresponding to the processing units of the device, as a program causing a computer to execute these steps, as information or data or signals indicating the program. Furthermore, the program, information, data, and signals may be distributed via a recording medium such as a CD-ROM or a communication medium such as the Internet.

Hereinafter, an embodiment of the present disclosure is described in detail with reference to the drawings. It is to be noted that each of the embodiments described below indicates a specific example of the present disclosure. The numerical values, shapes, materials, constituent elements, the arrangement and connection of the constituent elements, steps, the processing order of the steps, etc., indicated in the following embodiments are mere examples, and therefore do not limit the scope of the present disclosure. Furthermore, among the constituent elements in the following embodiments, constituent elements not recited in any one of the independent claims that define the most generic concept of the present disclosure are described as optional constituent elements that constitute one or more preferred embodiments. In addition, in the present DESCRIPTION and the drawings, substantially the same constituent elements having substantially the same functional configuration are assigned the same reference sign and an overlapping description is omitted.

### Embodiment 1

Hereinafter, a living body position estimation method that is performed by sensor 1 according to Embodiment 1 is described with defence to the drawings.

### [Configuration of Sensor 1]

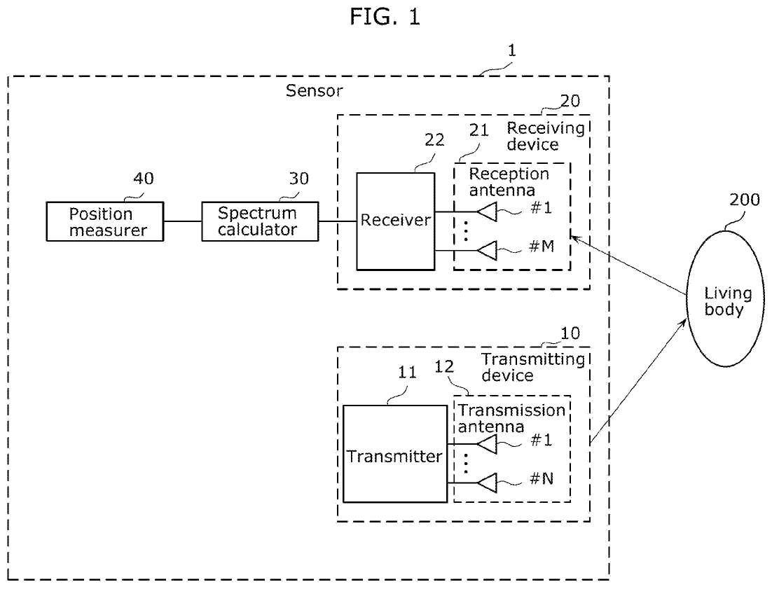

FIG. 1 is a block diagram illustrating a configuration of sensor 1 according to Embodiment 1. FIG. 1 illustrates sensor 1 together with a living body which is a measurement target.

Sensor 1 according to Embodiment 1 includes transmitting device 10, receiving device 20, spectrum calculator 30, and position measurer 40.

### [Transmitting Device 10]

Transmitting device 10 includes transmitter 11 and transmission antenna 12.

Transmission antenna 12 includes N transmission antenna elements (N being a natural number of two or more) from #1 to #N. Transmission antenna 12 includes an array antenna including N elements. Transmission antenna 12 is, for example, 4-element patch array antenna having an array element antenna interval of a half wavelength. Transmission antenna 12 transmits high-frequency signals generated by transmitter 11.

Transmitter 11 generates a high-frequency signal used to estimate presence/absence of one or more living bodies 200, the position(s) thereof, and/or the number thereof. Transmitter 11 transmits, to a measurement target region, a transmission signal that has been generated, using the N transmission antenna elements included in transmission antenna 12. For example, transmitter 11 generates 2.4 GHz continuous waves (CWs) and transmits generated CWs as transmission waves from transmission antenna 12. It is to be noted that the signals that are transmitted are not limited to CWs, and the signals may be, for example, signals modulated using orthogonal frequency division multiplexing (OFDM) for example.

### [Receiving Device 20]

Receiving device 20 includes reception antenna 21 and receiver 22.

Reception antenna 21 includes M reception antenna elements (M is a natural number of two or more) from #1 to #M. Reception antenna 21 includes an array antenna including M elements. Reception antenna 21 is, for example, 4-element patch array antenna having an array element antenna interval of a half wavelength. Reception antenna 21 receives high-frequency signals by the array antenna. Specifically, each of the M reception antenna elements included in reception antenna 21 receives reception signals transmitted from the N transmission antenna elements and including signals reflected by living body 200 when living body 200 is present.

Receiver 22 observes, for a predetermined period, reception signals received by the M reception antenna elements and including one or more reflection signals resulting from one or more of the transmission signals transmitted by the N transmission antenna elements being reflected by the living body. Receiver 22 converts the high-frequency signals received by reception antenna 21 into processable low-frequency signals using a down converter, for example. It is to be noted that, when transmitting device 10 is transmitting modulated signals, receiver 22 may demodulate the modulated signals. Receiver 22 transmits the modulated low-frequency signals to spectrum calculator 30.

Although transmitting device 10 and receiving device 20 are arranged adjacent to each other in FIG. 1, such an arrangement is a non-limiting example. It is to be noted that these devices may be arranged at apart positions.

In addition, in FIG. 1, although transmission antenna 12 that is used by transmitting device 10 and reception antenna 21 that is used by receiving device 20 are arranged at different positions as different ones, such an arrangement is a non-limiting example. One of transmission antenna 12 used by transmitting device 10 and reception antenna 21 used by receiving device 20 may serve as both transmission antenna 12 and reception antenna 21. Furthermore, transmitting device 10 and receiving device 20 may also serve as a Wi-Fi (registered trademark) router or hardware such as a wireless slave machine. In addition, although the use frequency taken as an example in the embodiment is 2.4 GHz, another frequency that is for example 5 GHz or a milli-wave band may be used.

### [Spectrum Calculator 30]

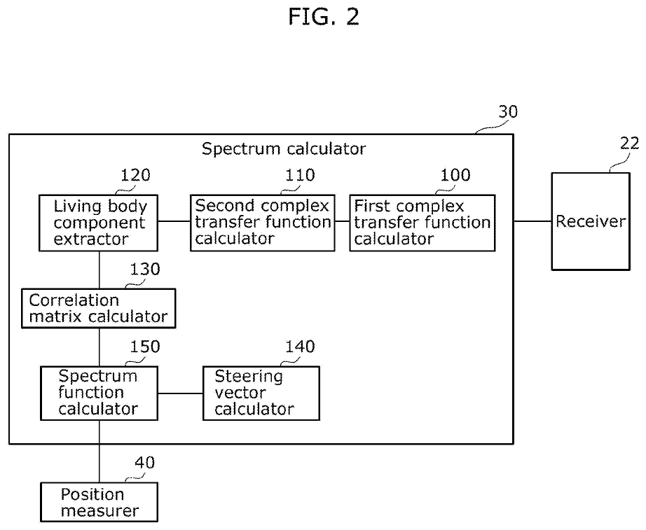

FIG. 2 is a block diagram illustrating a configuration of spectrum calculator 30 according to Embodiment 1.

Spectrum calculator 30 includes first complex transfer function calculator 100, second complex transfer function calculator 110, living body component extractor 120, correlation matrix calculator 130, steering vector calculator 140, and spectrum function calculator 150. Spectrum calculator 30 calculates a position spectrum function from the reception signals observed by receiving device 20, and passes the position spectrum function to position measurer 40.

### [First Complex Transfer Function Calculator 100]

First complex transfer function calculator 100 calculates first complex transfer functions obtained by recording an M×N complex transfer function matrix in time series during a first period, from the reception signals received respectively by the M reception antenna elements during a predetermined period. The M×N complex transfer function matrix includes complex transfer functions as components, the complex transfer functions each indicating characteristics of propagation between a corresponding one of the N transmission antenna elements and a corresponding one of the M reception antenna elements. Specifically, for each of M×N combinations that are all the possible combinations as a result of combining the N transmission antenna elements and the M reception antenna elements one-to-one, first complex transfer function calculator 100 calculates, using M reception signals observed by receiving device 20 during the predetermined period, a complex transfer function indicating characteristics of propagation between the transmission antenna element and the reception antenna element in the combination, thus calculating a first complex transfer function matrix. It is to be noted that, the first period is a period corresponding to the cycle of an activity (vital activity) of living body 200, and is shorter than the cycle (change period of living body 200) of at least one of respiration, a heartbeat, or motion of living body 200. In the present embodiment, first complex transfer function calculator 100 calculates first complex transfer functions obtained by calculating complex transfer functions each indicating characteristics of propagation between a corresponding one of the N transmission antenna elements and a corresponding one of the M reception antenna elements, from low-frequency signals transmitted by receiver 22, and recording the observed signals in time series. It is to be noted that the first complex transfer functions calculated by first complex transfer function calculator 100 may include reflected waves and/or scattered waves as a result of one or more of the transmission waves transmitted from transmission antenna 12. Furthermore, the first complex transfer functions calculated by first complex transfer function calculator 100 may include reflected waves reaching not via living body 200 such as direct waves from transmission antenna 12 and reflected waves from a fixed object.

First complex transfer function H₀ (t) is represented by an M-row N-column complex number matrix according to Expression 1 as indicated below.

$$[ Math . 1 ]$$

$${H}_{0} ( t ) = ( \begin{matrix}{h}_{11} ( r ) & … & {h}_{1 N} ( r ) \\ ⋮ & ⋱ & ⋮ \\ {h}_{M 1} ( r ) & … & {h}_{MN} ( r )\end{matrix} ) \qquad ( Expression 1 )$$

Here, hᵢⱼ (t) indicates propagation characteristics between j-th transmission antenna element and i-th reception antenna element. In addition, t denotes a variable indicating a point of time.

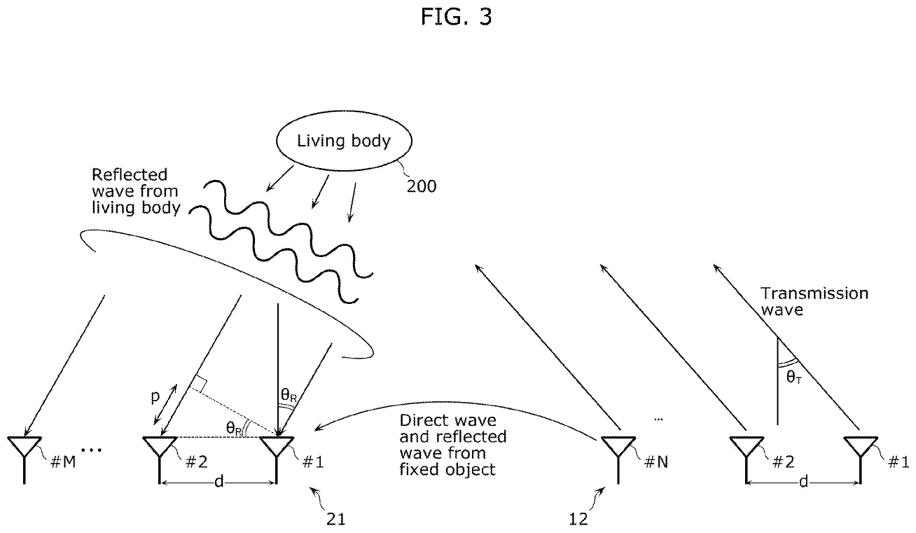

FIG. 3 is a diagram conceptually illustrating a state in which signal waves are transmitted in sensor 1 illustrated in FIG. 1. As illustrated in FIG. 3, one or more of the transmission waves transmitted from the transmission antenna elements of transmission antenna 12 are reflected by living body 200, and reaches the reception antenna elements of reception antenna 21. Here, reception antenna 21 is a reception array antenna that includes the M reception antenna elements, and is a linear array in which the elements are arranged at element intervals d. In addition, the orientation of living body 200 seen from the front of reception antenna 21 is θ. Living body 200 and reception antenna 21 are sufficiently distant from each other, and a reflected wave from the living body that arrives at reception antenna 21 can be considered as a plane wave.

### [Second Complex Transfer Function Calculator 110]

Second complex transfer function calculator 110 calculates second complex transfer functions during a second period that is not included in the first period by performing linear prediction onto the first complex transfer functions to estimate M×N complex transfer functions in time series. Specifically, second complex transfer function calculator 110 may calculate second complex transfer function Hi (t) using as linear prediction, for example, an autoregressive model (AR) model onto first complex transfer function H₀ (t). Specifically, second complex transfer function calculator 110 performs linear prediction for obtaining values at points of time after the point of time at which first complex transfer function H₀ (t) is recorded by applying the AR model onto each of all of the M×N elements of first complex transfer function H₀ (t).

Here, a description is given, using expressions, of a method of performing linear prediction of h (t) which is the first complex transfer function between one of the transmission antenna elements and a corresponding one of the reception antenna elements which are representative examples. The AR model for predicting h (t) at point of time t is represented according to Expressions 2 and 3 indicated below.

$$[ Math . 2 ]$$

$$h ( t ) = - {\sum }_{i = 1}^{m} {a}_{i}^{( m )} h ( t - i ) + w ( t ) \qquad ( Expression 2 )$$

$$[ Math . 3 ]$$

$$\begin{matrix}{a}_{i}^{( m )} = {a}_{i}^{( m - 1 )} + {κ}_{m} {a}_{m - i}^{( m - 1 )} & ( Expression 3 )\end{matrix}$$

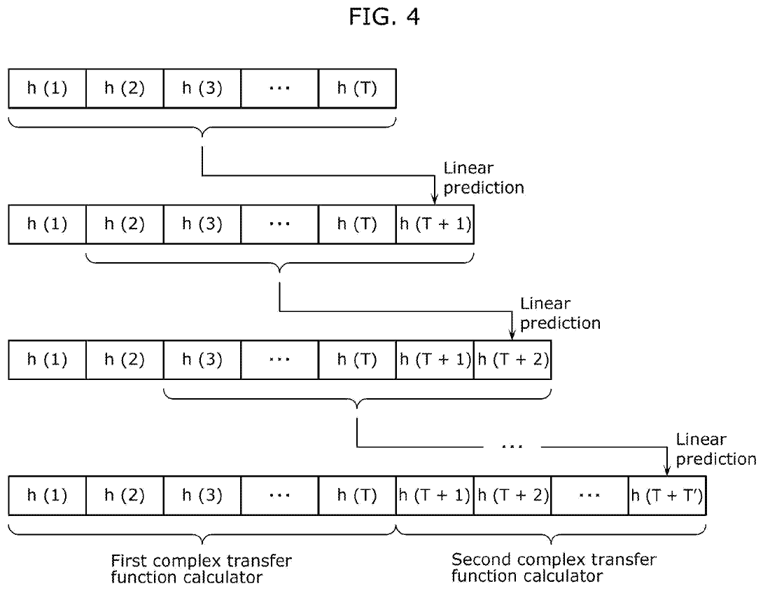

Here, aⱼ^{(m)} denotes a coefficient of the AR model called AR coefficient, m denotes an order for determining the number of data to be used for prediction, and w (t) denotes white noise. In addition, reflection coefficient kₘ in the AR coefficient can be determined according to the Burg method for example. The use of Expressions 2 and 3 makes it possible to calculate, from values of h (t) measured m times in the past, the value of h (t) at the next measurement time. By applying this recursively as indicated in FIG. 4, it is possible to calculate second complex transfer functions at any point of time before the point of time of the corresponding first complex transfer function.

The complex transfer function calculated by linear prediction is referred to as a second complex transfer function.

In this embodiment, linear prediction in a second period is performed. The second period is from latest point of time T to the point of time that is after the latest point of time by T′ second(s) among the points of time of recording of the first complex transfer functions. It is desirable that the length T′ of the second period in which linear prediction is performed be three or more seconds so that the vital signal of a vital activity such as respiration of living body 200 is sufficiently reflected. In this way, the second period is a future period after the first period. Alternatively, the second period may have a length longer than or equal to the cycle of the vital activity that is the measurement target. Alternatively, a total length of the first period and the second period is set to a predetermined length according to the type of the vital activity that is the measurement target. The predetermined length may be longer than or equal to the cycle of the type of the vital activity that is the measurement target. For example, when the type of the vital activity that is the measurement target is respiration, the predetermined length is three seconds. Alternatively, the length of the first period and the length of the second period may be equal to or different from each other. Alternatively, the second period is not limited to the period after the first period, and may be a period before the first period as long as the second period is not included in the first period.

Although the description regarding the AR model is provided here, linear prediction may be performed using a moving average (MA) model or an autoregressive moving average (ARMA) model.

### [Living Body Component Extractor 120]

Living body component extractor 120 extracts living body components which are variable components that changes over time, using first complex transfer functions and second complex transfer functions. These living body components may include living body components which are signal components reflected or scattered by one or more living bodies 200, in addition to variations due to noise. Here, examples of methods of extracting such variable components include a method of transforming to a frequency domain such as Fourier transform and then extracting only predetermined frequency components, and a method of calculating the difference between complex transfer functions at two different points of time to extract the difference. By performing any of these methods, components of reflected waves obtained via direct waves and a fixed object are removed, and only living components via one or more living bodies 200 and noise remain. For example, 0.3 Hz to 3 Hz components are extracted using five-second complex transfer functions, and variable components including respiration components which are present even when the one or more living bodies stay still are extracted. The complex transfer functions used here may be both first complex transfer functions and second complex transfer functions, or only the second complex transfer functions among the first complex transfer functions and the second complex transfer functions. When only the second complex transfer functions are used, a delay until a final measurement result is output decreases but a measurement accuracy decreases due to an error caused by linear prediction. For this reason, it is desirable that the length of the first complex transfer functions to be used be determined according to the allowable amount of delay. In this way, living body component extractor 120 extracts, using the first complex transfer functions and the second complex transfer functions, a living-body component complex transfer function matrix belonging to a predetermined frequency range corresponding to components affected by one or more vital activities that include at least one of respiration, a heartbeat, or motion of the living body. Although 0.3 Hz to 3 Hz components are extracted as one example of predetermined frequency components, it is to be noted that, when a slower operation or a faster operation is desired to be extracted, frequency components to be extracted may be changed according to frequency components of the operation to be extracted as a matter of course.

Since the number of transmission antenna elements included in the transmission array antenna and the number of reception antenna elements included in the transmission array antenna are N and M, respectively, that are plural, it is to be noted that the number of variable components of the complex transfer functions corresponding to the transmission and reception array antennas are also plural. Hereinafter, M-row N-column living body component channel matrix F (f) which is calculated by combining these is represented according to Expression 4. It is to be noted that the living body component channel matrix is also referred to as a living body component complex transfer function matrix.

$$[ Math . 4 ]$$

$$F ( f ) = ( \begin{matrix}{F}_{11} ( f ) & … & {F}_{1 N} ( f ) \\ ⋮ & ⋱ & ⋮ \\ {F}_{M 1} ( f ) & … & {F}_{MN} ( f )\end{matrix} ) \qquad ( Expression 4 )$$

It is to be noted that each element Fᵢⱼ of the living body component complex transfer function matrix is a component obtained by extracting a variable component from a corresponding component hᵢⱼ of a complex transfer function matrix H. In addition, living body component channel matrix F (f) includes functions of frequencies or difference cycles f thereof, and includes information corresponding to a plurality of frequencies.

### [Correlation Matrix Calculator 130]

Correlation matrix calculator 130 rearranges the elements of the M-row N-column living body component channel matrix calculated by living body component extractor 120 to generate M×N-row one-column living body component channel vector F_{vec} (f). Components can be arranged according to, for example, the method as indicated by Expression 5, yet the order of calculation is not limited as long as an operation of rearranging the components in a matrix is performed. It is to be noted that the living body component channel vector is also referred to as a living body component complex transfer function vector.

$$[ Math . 5 ]$$

$${F}_{vec} ( f ) = vec [ F ( f ) ] = {[ {F}_{11} ( f ) ⋯ {F}_{M 1} ( f ) {F}_{12} ( f ) ⋯ {F}_{M 2} ( f ) ⋯ {F}_{1 N} ( f ) ⋯ {F}_{MN} ( f ) ]}^{T} \qquad ( Expression 5 )$$

Subsequently, correlation matrix calculator 130 calculates a correlation matrix in the frequency direction of the living body component channel vector. More specifically, correlation matrix calculator 130 calculates correlation matrix R of the variable component channel vectors including a plurality of variable components changed due to living body 200 and noise according to Expression 6. Correlation matrix R is constituted by M×N rows and M×N columns.

[Math. 6]

R=E[F_{vec}(f)F_{vec}(f)^{H}] (Expression 6)

Here, E [ ] in Expression 6 indicates an averaging operation, and operator H denotes complex conjugate transpose. Here, the living body component channel vector including the plurality of frequency components in the calculation of the correlation matrix is calculated by calculating correlation matrix R averaged in the frequency direction. This allows sensing using information included in the respective frequencies at the same time. In other words, even when a particular frequency that is for example a 1 Hz component is weak, sensing is possible using, for example, 0.9 Hz and 1.1 Hz information. It is to be noted that, in order to use only frequencies having large living body components, in the averaging operation according to Expression 6, only frequencies at which a total sum or a maximum value of the absolute value of components of F_{vec} (f) is greater than or equal to a certain value may be selected.

### [Steering Vector Calculator 140]

Steering vector calculator 140 calculates transmission steering vectors and reception steering vectors and combined steering vectors that are generated in consideration of both the transmission and reception steering vectors, and transmits them to spectrum function calculator 150.

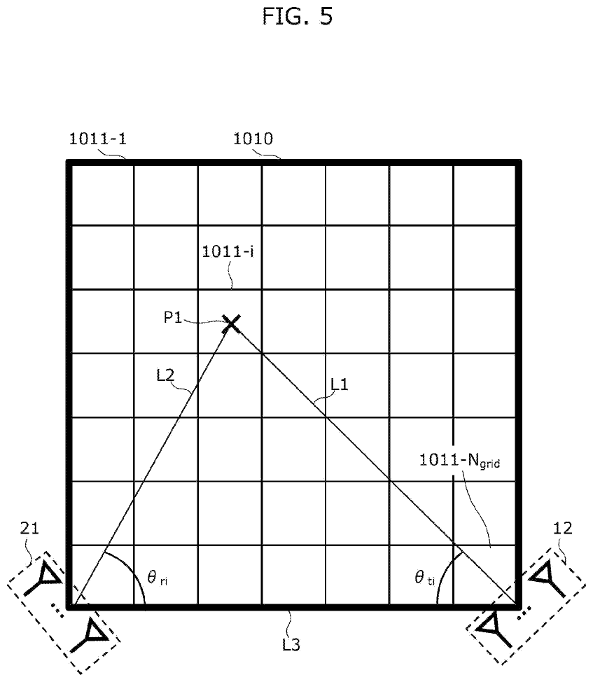

Steering vector calculator 140 divides measurement target region 1010 targeted by sensor 1 into N_{grid} regions 1011-1 to 1011-N_{grid}. Next, steering vector calculator 140 calculates, for each of regions 1011-1 to 1011-N_{grid} into which measurement target region 1010 is divided, angles θₜᵢ and θᵣᵢ between a reference line and two straight lines obtained by connecting a representative point in the region and each of the position of transmission antenna 12 and the position of reception antenna 21. Here, i denotes an integer from 1 to N_{grid}. The representative point in the region is a point at a center of gravity or an upper right corner of the region, for example. In addition, the reference line is a straight line that connects the position of transmission antenna 12 and the position of reception antenna 21, for example. A relation of dividing the region and angles θₜᵢ and θᵣᵢ to be obtained is illustrated in FIG. 5.

As illustrated in FIG. 5, angle θₜᵢ for region 1010-i is an angle between reference line L3 and straight line L1 that connects representative point P1 in region 1010-i and the position of transmission antenna 12. Angle θᵣᵢ for region 1010-i is an angle between reference line L3 and straight line L2 that connects representative point P1 in region 1010-i and the position of reception antenna 21. Representative point P1 in region 1010-i is the center of gravity of region 1010-i, for example.

More specifically, the steering vectors (direction vectors) of the transmission array antenna are calculated by steering vector calculator 140 according to Expression 7.

[Math. 7]

a_{T}(θ_{T})=[1,e^{-jkd sin θ}^{_{T}}, . . . ,e^{-jkd(N-1)sin θ}^{_{T}}]^{T} (Expression 7)

The steering vectors (direction vectors) of the reception array antenna are calculated according to Expression 8.

[Math. 8]

a_{R}(θ_{R})=[1,e^{-jkd sin θ}^{_{R}}, . . . ,e^{-jkd(N-1)sin θ}^{_{R}}]^{T} (Expression 8)

Here, k denotes a wavenumber. Furthermore, steering vector calculator 140 multiplies these steering vectors to calculate steering vectors obtained in consideration of the information about the angles of both the transmission and reception array antennas as indicated in Expression 9.

[Math. 9]

a(θ_{T},θ_{R})=vec{a_{T}(θ_{T})a_{R}^{T}(θ_{R})} (Expression 9)

It is to be noted that a steering vector is a function of θ_{T} and θ_{R}, and θ_{T} and θ_{R} are determined correspondingly to the positions of the plurality of divided N_{grid} regions 1011-1 to 1011-N_{grid}. In other words, when the measurement target region is divided into the plurality of regions, steering vector calculator 140 calculates a steering vector constituted by elements corresponding to the positions of the plurality of regions. A steering vector is also represented as a function of intersecting point X between the straight line that extends from the transmission antenna in the direction of θ_{T} and the straight line that extends from the reception antenna in the direction of θ_{R}. For this reason, the steering vector is indicated as a (X) for simplicity hereinafter. Steering vector calculator 140 then transmits steering vector a (X) to spectrum function calculator 150.

### [Spectrum Function Calculator 150]

Spectrum function calculator 150 calculates a position spectrum function using the correlation matrix calculated by correlation matrix calculator 130 and the steering vector calculated by steering vector calculator 140. The position spectrum function is a spectrum function indicating a likelihood that living body 200 is present. Methods of calculating a position spectrum function include the BeamFormer method, the Capon method, the MUltiple SIgnal Classification (MUSIC) method, etc. In this embodiment, a method using the MUSIC method is described as one example. In other words, in this embodiment, spectrum function calculator 150 calculates a spectrum function according to the MUSIC method. When performing eigenvalue decomposition on a correlation matrix calculated by correlation matrix calculator 130, the result is represented as indicated according to Expressions 10 to 12 indicated below.

[Math. 10]

R=UΛU^{H} (Expression 10)

[Math. 11]

U=[u₁, . . . ,u_{L},u_{L+1}, . . . ,u_{MN}] (Expression 11)

[Math. 12]

Λ=diag[λ₁, . . . ,λ_{L},λ_{L+1}, . . . ,λ_{MN}] (Expression 12)

Here, it is assumed that Expression 11 indicates an eigenvector having M×N elements, and that Expression 12 indicates an eigenvalue corresponding to the eigenvector, and the order is λ₁≥λ₂≥ . . . ≥λ_{L}≥λ_{L+1} . . . λ_{MN}. L denotes the-number-of-humans information in the region in which a sensor is disposed. When the maximum number of humans who can be present in a region can be predicted in advance, the number-of-humans information may be determined to be the maximum number or the number which is greater than the maximum number by 1 or 2. Alternatively, when the number of humans are known by another means, the number-of-humans information may be determined to be the known number.

Furthermore, the MUSIC method is applied thereto.

Specifically, spectrum function calculator 150 calculates the spectrum of position spectrum function P_{music} (X) indicated according to Expression 13 using the steering vector multiplied based on the MUSIC method.

$$[ Math . 13 ]$$

$${P}_{music} ( X ) = \frac{1}{{\vert {a}^{H} ( X ) [ {u}_{L + 1} , … , {u}_{MN} ] \vert}^{2}} \qquad ( Expression 13 )$$

### [Position Measurer 40]

Position measurer 40 searches a local maximum value of a position spectrum function calculated by spectrum function calculator 150, and estimates the position at which the local maximum value is obtained as the position of the living body. Specifically, position measurer 40 searches the set of coordinates at which the local maximum value is obtained in the position spectrum function from the sets of coordinates within the measurement target region by sensor 1. At this time, in order to exclude virtual images due to influence of noise, the range in which the values of position spectrum functions are less than or equal to a predetermined threshold value may be excluded from the target of the local maximum value search. Although estimation of the position of the living body on a two-dimensional plane has been described in the embodiment, it is to be noted that three-dimensional estimation is also possible by performing similar measurement also in the height direction. In addition, the number of local maximum values searched out may be output as the-number-of-humans information.

Although the embodiment describes the example of the configuration in which each of transmission antenna 12 and reception antenna 21 is a plurality of multiple-inputs multiple-outputs (MIMOs), it is to be noted that one of the transmission antenna and reception antenna may be configured to have a signal antenna element. In this case, the MUSIC spectrum that is output by spectrum function calculator 150 is a one-dimensional vector, but even in this case, it is possible to perform position estimation using peak search as in the case of using a two-dimensional vector.

### [Configuration of Sensor 1]

Next, a description is given of living body position estimation processing that is performed by sensor 1 configured as described above.

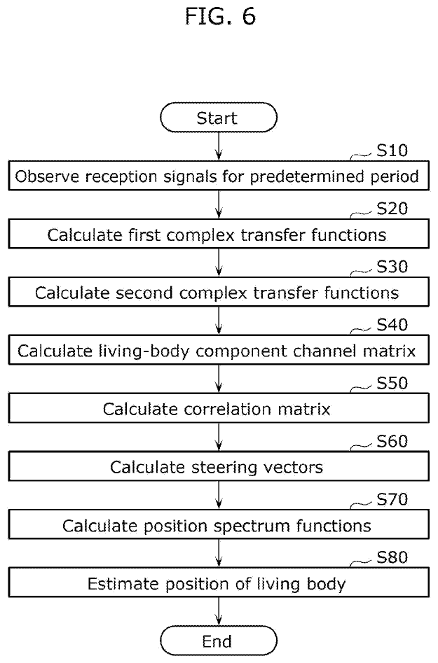

FIG. 6 is a flow chart indicating the living body position estimation processing by sensor 1 according to Embodiment 1.

First, sensor 1 transmits transmission signals to a measurement target region, and observes reception signals for a predetermined period (S10).

Next, sensor 1 calculates first complex transfer functions from the reception signals observed in Step S10, and records the first complex transfer functions in time series during a first period (S20).

Sensor 1 then calculates second complex transfer functions using linear prediction from the first complex transfer functions calculated (S30).

Next, sensor 1 extracts variable components from the second complex transfer functions calculated to calculate a living body component channel matrix (S40).

Next, sensor 1 calculates a correlation matrix of the living body channel matrix extracted (S50).

Sensor 1 then calculates steering vectors corresponding to weights of transmission antenna elements and reception antenna elements (S60).

Subsequently, sensor 1 calculates position spectrum functions according to the MUSIC method using the steering vectors calculated in Step S60 and the correlation matrix calculated in Step S50 (S70).

Lastly, sensor 1 searches for the local maximum value of the position spectrum function calculated in Step S70, estimates the position at which the local maximum value is indicated in the position spectrum function as the position of the living body, and outputs the estimated position of the living body (S80).

### Advantageous Effects, Etc.

With sensor 1 according to the embodiment, the position of the living body which is present in the measurement target region is estimated using not only the first complex transfer functions obtained through observation in the first period but also the second complex transfer functions in the second period different from the first period estimated using the first complex transfer functions. For this reason, it is possible to shorten the actual observation period by the time corresponding to the second period, and to estimate the position of the living body with short delay time. Furthermore, even when it is impossible to sufficiently separate noise and living body components by eigenvalue decomposition because of insufficient observation time of the first complex transfer functions, additional use of information about second complex transfer functions calculated through linear prediction makes it possible to sufficiently separate the noise and the living body components by eigenvalue decomposition, thereby enabling estimation of the position of the living body with high accuracy.

### Embodiment 2

An example has been described where spectrum calculator in sensor 1 in Embodiment 1 calculates a single position spectrum function for each of the first complex transfer functions and a corresponding one of the second complex transfer functions. A description is given of a method in which sensor 1A in Embodiment 2 divides each of the first complex transfer functions and a corresponding one of the second complex transfer functions into a plurality of segments, and calculates a position spectrum function for each of the segments, so that the position of living body 200 can be estimated even when living body 200 is moving in a period during which receiving device 20 is observing signals.

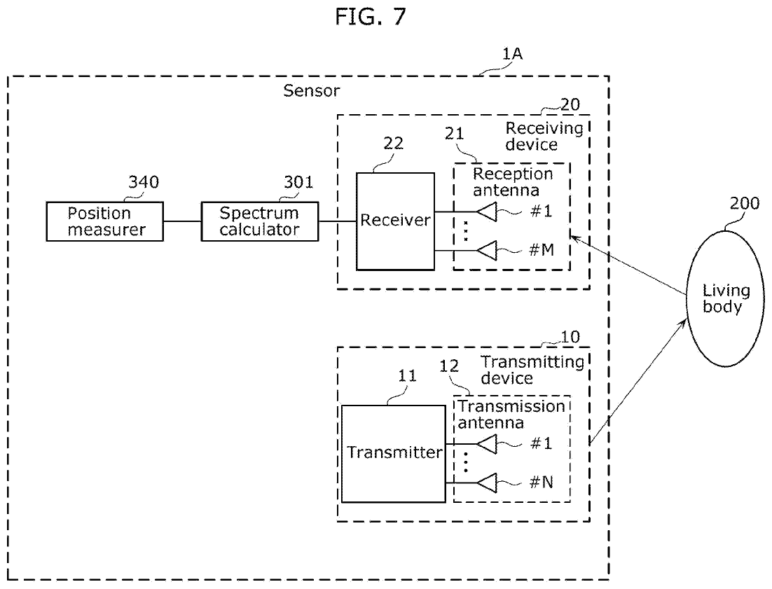

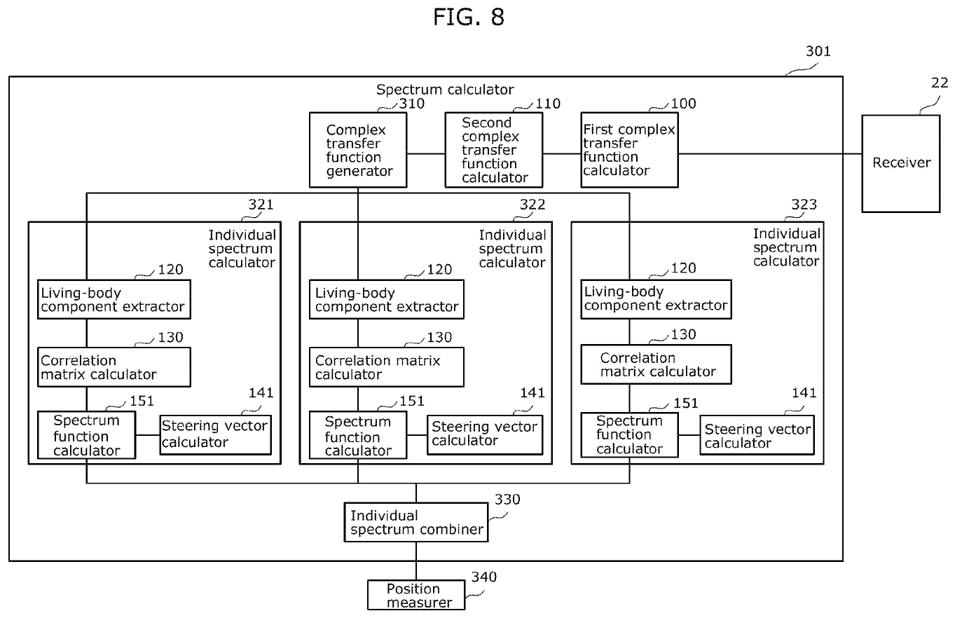

FIG. 7 is a block diagram illustrating a configuration of sensor 1A according to Embodiment 2. FIG. 8 is a block diagram illustrating a specific configuration of spectrum calculator 301 according to Embodiment 2.

It is to be noted that the configurations of transmitting device 10 and receiving device 20 and the configurations of first complex transfer function calculator 100 and second complex transfer function calculator 110 in spectrum calculator 301 are identical to those in Embodiment 1, and thus the same reference signs as in Embodiment 1 are assigned thereto and the descriptions thereof are omitted here.

### [Complex Transfer Function Generator 310]

Complex transfer function generator 310 divides, into a predetermined number of functions, the first complex transfer functions and second complex transfer functions transmitted from first complex transfer function calculator 100 and second complex transfer function calculator 110. Here, the complex transfer functions obtained through the dividing are referred to as third complex transfer functions. In other words, when complex transfer function generator 310 divides the functions into S functions (S is a natural number of two or more), the number of third complex transfer functions is also S. In this way, complex transfer function generator 310 generates S third complex transfer functions in mutually different S periods, from the first complex transfer functions and second complex transfer functions. The S periods corresponding respectively to the S third complex transfer functions may each have a partly overlapping period or a period without an overlapping period with any other period. In the present embodiment, two adjacent periods in the S periods are consecutive and without an overlapping period with any other period. Here, it is desirable that the period of each of the third complex transfer functions be longer than the cycle of respiration which is represented by a representative living body signal, for example, approximately three seconds. Complex transfer function generator 310 transmits S (three in the present embodiment) third complex transfer functions respectively to S (three in the present embodiment) individual spectrum calculators 321 to 323. Although FIG. 8 illustrates an example in which spectrum calculator 301 is configured to include three individual spectrum calculators 321 to 323, it is to be noted that the number of individual spectrum calculators may be two or more.

### [Individual Spectrum Calculators 321 to 323]

Each of individual spectrum calculators 321 to 323 which are the S individual spectrum calculators generates a position spectrum function using a corresponding one of the third complex transfer functions among the S third complex transfer functions generated by complex transfer function generator 310. For this reason, S position spectrum functions are generated. Individual spectrum calculators 321 to 323 operate in the same manner, and thus individual spectrum calculator 321 is described as an example here. Individual spectrum calculator 321 includes living body component extractor 120, correlation matrix calculator 130, steering vector calculator 141, and spectrum function calculator 151 as illustrated in FIG. 8. Living body component extractor 120 and correlation matrix calculator 130 among the constituent elements are not described here because these constituent elements operate by replacing each of the first complex transfer functions and a corresponding one of the second complex transfer functions with a single third complex transfer function as the complex transfer function that is input to living body component extractor 120 in Embodiment 1.

### [Steering Vector Calculator 141]

It has been described that steering vector calculator 140 in Embodiment 1 calculates steering vector a (X) assuming that the position of living body 200 which is the position measurement target at the point of time at which a signal is observed and the current position of living body 200 are the same. Steering vector calculator 141 in Embodiment 2 calculates a steering vector assuming that the current position of living body 200 changes from the position of living body 200 at the point of time ts at which s-th third complex transfer function is observed. Specifically, steering vector calculator 141 first calculates steering vector a (X) using Expressions 7, 8, and 9 in the same manner as in Embodiment 1. Steering vector calculator 141 then performs transform using Expression 14 for steering vector a (X) calculated, in order to reflect the difference between the current position of living body 200 and the position of living body 200 at point of time ts.

[Math. 14]

aₛ(X,ΔX)=a(X+ΔX) (Expression 14)

Here, aₛ (X, ΔX) is referred to as an extended steering vector. Here, ΔX indicates a displacement by which the living body can move between the current point of time and point of time ts. Although ΔX can take an unlimited number in principle, the distance by which a living body can move in a certain period of time is actually limited, and the possible value range for ΔX if further quantized is limited. In other words, steering vector calculator 141 calculates steering vector aₛ (X, ΔX) for K (a natural number of two or more) discrete values in the possible value range for ΔX, and passes K steering vectors aₛ (X, ΔX) calculated to spectrum function calculator 151. For this reason, S steering vector calculators 141 included respectively in S individual spectrum calculators 321 to 323 calculates S×K extended steering vectors by calculating S steering vectors constituted by elements corresponding respectively to the positions of a plurality of regions into which a measurement target region is divided and performing mapping using a corresponding one of mapping variables. The corresponding one of mapping variables is one of K possible values (K is a natural number of two or more. In this embodiment, a mapping variable is displacement ΔX. It is to be noted that a mapping variable is not limited to displacement ΔX, and may be a value relating to displacement ΔX, that is for example, a velocity that is calculated by differentiating ΔX once or an acceleration that is calculated by differentiating ΔX twice.

### [Spectrum Function Calculator 151]

Spectrum function calculator 151 calculates extended spectrum function Pₛ (X, ΔX) indicated by Expression 15 using K extended steering vectors aₛ (X, ΔX) passed from steering vector calculator 141. For this reason, S spectrum function calculators 151 included respectively in S individual spectrum calculators 321 to 323 calculate S×K extended spectrum functions which are functions having, as variables, the positions in the plurality of regions and mapping variables and indicate likelihoods that a living body is present, using the correlation matrix and the S×K extended steering vectors.

$$[ Math . 15 ]$$

$${P}_{s} ( X , Δ X ) = \frac{1}{{\vert {a}_{s}^{H} ( X , Δ X ) [ {u}_{L + 1} , … , {u}_{MN} ] \vert}^{2}} \qquad ( Expression 15 )$$

Here, spectrum function calculator 151 calculates spectrum functions according to the MUSIC method in the same manner as spectrum function calculator 150 according to Embodiment 1. It is to be noted that spectrum functions are not limited to the spectrum functions according to the MUSIC method, and other spectrum functions according to the Capon method, or the like may be used.

### [Individual Spectrum Combiner 330]

Individual spectrum combiner 330 combines S×K extended spectrum functions Pₛ (X, ΔX) transmitted from S individual spectrum calculators 321 to 323 into a single position spectrum function. Specifically, individual spectrum combiner 330 calculates a direct product set A which is a possible combination ranging from A₁ to Aₛ in the case where a set possible for ΔX at point of time ts is Aₛ. Here, for convenience, a number is assigned to each of the elements of direct product set A. The n-th element of A is constituted with values indicating S displacements, and the S-th element is denoted as Xₙₛ. Individual spectrum combiner 330 calculates a combined spectrum function indicated according to Expression 16 for each of all the elements of the direct product set A. In this way, individual spectrum combiner 330 combines, for each of K mapping variables, S extended spectrum functions calculated using the mapping variables as variables among the S×K extended spectrum functions, to calculate K combined spectrum functions.

$$[ Math . 16 ]$$

$${P}_{M} ( X , n ) = \frac{1}{\frac{1}{{P}_{1} ( X , {x}_{n 1} )} + ⋯ + \frac{1}{{P}_{s} ( X , {x}_{ns} )} + ⋯ + \frac{1}{{P}_{S} ( X , {x}_{nS} )}} \qquad ( Expression 16 )$$

Although the embodiment indicates the example in which individual spectrum combiner 330 calculates the combined spectrum function using a harmonic average indicated according to Expression 16 as a non-limiting example, it is to be noted that a combined spectrum function may be calculated using an arithmetic average or a geometric average.

### [Position Measurer 340]

Position measurer 340 searches for the local maximum values of the K combined spectrum functions transmitted from spectrum calculator 301, and estimates the positions at which the K combined spectrum functions indicate the local maximum values. Alternatively, position measurer 340 may estimate the mapping variables that indicate the local maximum values as the mapping variables for a living body. Although position measurer in Embodiment 1 performs a search for coordinate variable X, position measurer 340 according to Embodiment 2 may search out a combined spectrum function not only for coordinate variable X but also for the elements of direct product set A (that is, K displacements ΔX which are K mapping variations). In this way, position measurer 340 calculates X and n which make the value of the combined spectrum function to be the local maximum value, and outputs the current position of the living body as the position obtained according to Xₘₐₓ+xₙₛ at point of time ts.

Although steering vector calculator 141 performs transform into the extended steering vectors according to Expression 14 in the embodiment, it is also excellent to derive position spectrum functions P_{music} (X) using steering vectors similar to those in Embodiment 1, and then calculate extended spectrum functions Pₛ (X, ΔX) by performing transform according to Pₛ (X, ΔX)=P_{music} (X+ΔX) for the position spectrum functions.

### [Operation Performed By Sensor 1A]

Next, a description is given of living body position estimation processing that is performed by sensor 1A configured as described above.

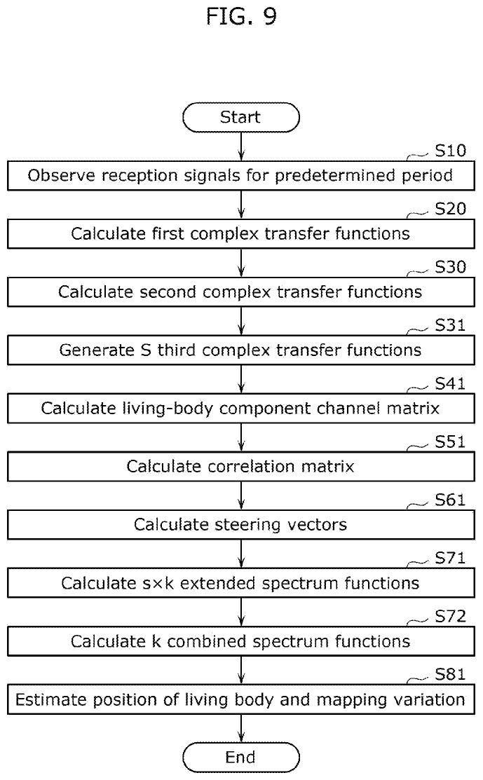

FIG. 9 is a flow chart indicating the living body position estimation processing by sensor 1A according to Embodiment 2.

First, sensor 1A transmits transmission signals to a measurement target region, and observes reception signals for a predetermined period (S10).

Next, sensor 1A calculates first complex transfer functions from the reception signals observed in Step S10, and records the first complex transfer functions in time series during a first period (S20).

Sensor 1A then calculates second complex transfer functions using linear prediction from the first complex transfer functions calculated (S30).

Next, sensor 1A generates S third complex transfer functions in mutually different S (S is a natural number of two or more) periods from the first complex transfer functions and the second complex transfer functions (S31).

Next, sensor 1A extracts, using the S third complex transfer functions, a living body component channel matrix (living-body component complex transfer function matrix) belonging to a predetermined frequency range corresponding to the components affected by one or more vital activities that include at least one of respiration, a heartbeat, or motion of the living body (S41).

Next, sensor 1A generates a living-body component complex transfer function vector by re-arranging elements of the living-body component complex transfer function matrix, and calculates a correlation matrix in a frequency direction of the living-body component complex transfer function vector obtained (S51).

Next, Sensor 1A calculate S steering vectors including elements corresponding respectively to the positions in the plurality of regions of a measurement target region in the case where the measurement target region has been divided into the plurality of regions and performs mapping using mapping variables that can take K (K is a natural number of two or more) values onto the respective S steering vectors, to calculate S×K extended steering vectors (S61).

Next, sensor 1A calculates S×K extended spectrum functions indicating a likelihood that the living body is present regarding the positions in the plurality of regions and mapping variables as variables, using the correlation matrix and the S×K extended steering vectors (S71).

Next, sensor 1A combines, for each of the K mapping variables, the S extended spectrum functions calculated using the mapping variables as the variables among the S×K extended spectrum functions, to calculate a corresponding one of K combined spectrum functions (S72).

Lastly, sensor 1 estimates that the position at which the K combined spectrum function indicates the local maximum value is the position of the living body, estimates that the mapping variable that indicates the local maximum value is the mapping variable of the living body, and outputs the position of the living body and mapping variable estimated (S81).

### Advantageous Effects, Etc.

With sensor 1A according to the present embodiment, the S third complex transfer functions at the S positions to which the living body has moved are generated using the radio signals, and the S positions of the living body present in the measurement target region assuming that the living body moves with constant mapping variables are estimated using the respective third complex transfer functions. For this reason, it is possible to track the positions of the living body even when the living body is moving. Furthermore, according to sensor 1A in the present embodiment, even when it is impossible to sufficiently separate noise and living body components by eigenvalue decomposition because of insufficient observation time of the first complex transfer functions, additional use of information about second complex transfer functions calculated through linear prediction makes it possible to sufficiently separate the noise and the living body components by eigenvalue decomposition, thereby enabling estimation of the position of the living body with high accuracy.

### Embodiment 3

Sensor 1A according to Embodiment 2 performs search by extended spectrum functions using the displacements of the living body from the current position at point of time ts as parameters. A description is given of a method using the velocities of the living body as intervening variables (mapping variables) in order to reduce the amount of calculation by narrowing the search range. It is to be noted that the configuration of the sensor is the same as in sensor 1A according to Embodiment 2, and thus the description is given also with reference to the block diagrams in FIGS. 7 and 8. In addition, the blocks for performing processing similar to those in Embodiment 2 are not described repeatedly.

### [Steering Vector Calculator 141]

Steering vector calculator 141 according to Embodiment 2 calculates extended steering vectors using displacements ΔX as parameters. Steering vector calculator 141 according to the present embodiment calculates extended steering vectors using velocities v of a living body as parameters. In other words, in Embodiment 3, velocities v of the living body are used as mapping variables. Velocities v are used because it is possible to regard that motions of the living body which is moving at the one or more velocities within a certain degree in a segment are certain uniform motions, and each of the amounts of displacements ΔX can be expressed by the product of velocity v and time ts−to when the motions of the living body are approximated by the uniform motions. Here, to is a current point of time. In other words, an extended steering vector can be represented according to Expression 17.

[Math. 17]

aₛ(X,ΔX)=a(X+ΔX)=a(X+v(tₛ−t₀))=a′ₛ(X,v) (Expression 17)

Here, a′ₛ (X, v) is referred to as a velocity extended steering vector.

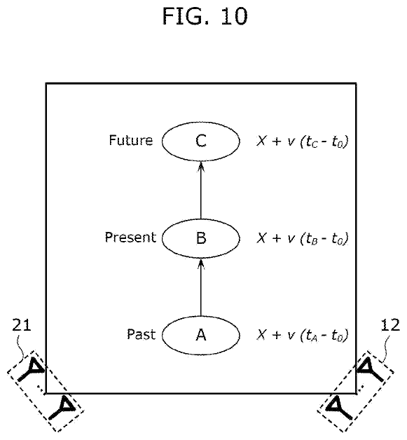

FIG. 10 is a diagram indicating the relation between velocity v and a displacement at point of time ts.

Here, an example in which complex transfer function generator 310 divides the first complex transfer functions and the second complex transfer functions into three third complex transfer functions A, B, and C in FIG. 10 is presented. The relation between A, B, and C is A<B<C in chronological order, and, for convenience, it is assumed that A, B, and C correspond to past, current, and future third complex transfer functions, respectively. As indicated in FIG. 10, determining velocity v can uniquely determine the amount of displacement at each of the points of time A, B, and C.

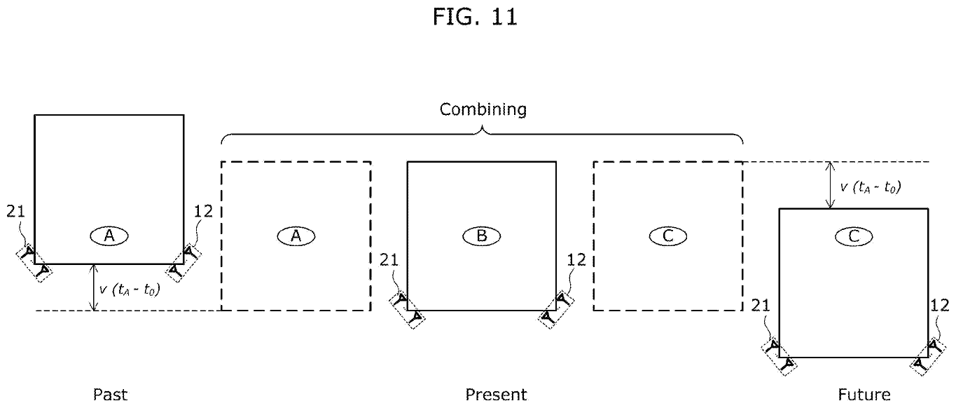

Here, FIG. 11 is a diagram that conceptually illustrates that the transform according to Expression 17 at each of A, B, and C is an operation for shifting the current steering vector by the amount of displacement that is expressed by the product of velocity v and time ts−to. It is to be noted that velocity v is a continuous amount, but possible values can be limited through quantization. In other words, in Embodiment 3, mapping variables are K discrete velocities. In addition, it should be noted that velocity v is expressed as a two-dimensional vector in the case of a plane positioning.

### [Spectrum Function Calculator 151]

Spectrum function calculator 151 calculates velocity extended spectrum function P′ₛ (X, v) indicated according to Expression 18 using velocity extended steering vector a′ₛ (X, v) passed from steering vector calculator 141. Velocity extended spectrum function P′ₛ (X, v) is one example of an extended spectrum function.

$$[ Math . 18 ]$$

$${P}_{s}^{′} ( X , v ) = \frac{1}{{\vert {a}_{s}^{′ H} ( X , v ) [ {u}_{L + 1} , … , {u}_{MN} ] \vert}^{2}} \qquad ( Expression 18 )$$

Here, spectrum function calculator 151 calculates spectrum functions according to the MUSIC method in the same manner as spectrum function calculator 150 according to Embodiment 1. It is to be noted that spectrum functions are not limited to the spectrum functions according to the MUSIC method, and other spectrum functions according to the Capon method, or the like may be used.

### [Individual Spectrum Combiner 330]

Individual spectrum combiner 330 combines S×K extended spectrum functions P′ₛ (X, v) transmitted from S individual spectrum calculators 321 to 323 into a single position spectrum function. Specifically, a combined spectrum function indicated according to Expression 19 is calculated for each of all V elements assuming that the set of possible values for velocity v is V. In this way, individual spectrum combiner 330 combines, for each of K velocities, S velocity extended spectrum functions calculated using the velocities as variables among the S×K velocity extended spectrum functions, to calculate a corresponding one of K combined spectrum functions.

$$[ Math . 19 ]$$

$${P}_{M}^{′} ( X , v ) = \frac{1}{\frac{1}{{P}_{1}^{′} ( X , v )} + ⋯ + \frac{1}{{P}_{s}^{′} ( X , v )} + ⋯ + \frac{1}{{P}_{S}^{′} ( X , v )}} \qquad ( Expression 19 )$$

Although the embodiment indicates the example in which individual spectrum combiner 330 calculates the combined spectrum function using a harmonic average indicated according to Expression 19 as a non-limiting example, it is to be noted that a combined spectrum function may be calculated using an arithmetic average or a geometric average.

### [Position Measurer 340]

Position measurer 340 searches for the local maximum values of the K combined spectrum functions transmitted from spectrum calculator 301, and estimates the positions at which the K combined spectrum functions indicate the local maximum values. In addition, position measurer 340 may estimate the velocities that indicate the local maximum values as the motion velocities of the living body. Position measurer 40 according to Embodiment 1 performs search for coordinate variable X, but position measurer 340 according to Embodiment 3 performs search not only for coordinate variable X but also for velocity v of a combined spectrum function. In this way, position measurer 340 calculates Xₘₐₓ and vₘₐₓ which make the value of the combined spectrum function to be the local maximum, and outputs Xₘₐₓ as the current position of the living body and vₘₐₓ as the motion velocity.

### Advantageous Effects, Etc.

With sensor 1A according to the present embodiment, the S third complex transfer functions at the S positions to which the living body has moved are generated using the radio signals, and the S positions of the living body present in the measurement target region assuming that the living body moves with constant velocities are estimated using the respective third complex transfer functions. For this reason, it is possible to track the positions of the living body even when the living body is moving. In addition, in comparison with sensor 1A according to Embodiment 2, since the parameters of a combined spectrum function are limited to position X and velocity v when there is a need to perform search, it is possible to reduce the amount of calculation and thus to perform position measurement with a shorter delay.

### OTHER EMBODIMENTS

Sensors 1 and 1A according to the above embodiments may transmit the position of the living body detected to a server connected via a network. For example, sensors 1 and 1A may sequentially detect the positions of the living body and periodically transmits, to the server, a data set including the plurality of positions of the living body that have been sequentially detected. The data set that is transmitted to the server may include only a single position of the living body detected at a timing, or may include a plurality of positions of the living body detected at respective timings in a predetermined period. The one or more positions included in the data set may be associated with one or more points of time detected. In other words, the data set may include the one or more positions of the living body and the one or more points of time at which the one or more positions of the living body have been detected. In addition, the data set may include identifiers of sensors 1 and 1A which detect the one or more positions and points of time.

The server obtains the data sets from sensors 1 and 1A, and accumulates the positions of the living body included in the data sets. The server may accumulate the one or more positions of the living body and the one or more points of time at which the one or more positions of the living body have been detected together with the identifiers of sensors 1 and 1A.

### INDUSTRIAL APPLICABILITY

The present disclosure is applicable to sensors capable of estimating the positions of living bodies with low delay utilizing radio signals, measurement devices which measure the positions of living bodies, home appliances which perform control according to the positions of living bodies, monitoring devices which detect intrusion of living bodies, or other devices.

### REFERENCE SIGNS LIST

1, 1A sensor
10 transmitting device
11 transmitter
12 transmission antenna
receiving device
21 reception antenna
22 receiver
30, 301 spectrum calculator
40, 340 position measurer
100 first complex transfer function
110 second complex transfer function
120 living body component extractor
130 correlation matrix calculator
140, 141 steering vector calculator
150, 151 spectrum function calculator
200 living body
310 complex transfer function generator
321-323 individual spectrum calculator
330 individual spectrum combiner

1. A sensor which detects a position of a living body, the sensor comprising:
a transmission antenna which includes N transmission antenna elements, N being a natural number of two or more;
a reception antenna which includes M reception antenna elements, M being a natural number of two or more;
a transmitter which transmits transmission signals to a measurement target region using the N transmission antenna elements;
a receiver which receives M reception signals which have been received respectively by the M reception antenna elements and include reflection signals resulting from the transmission signals transmitted respectively from the N transmission antenna elements being reflected by the living body;
a first complex transfer function calculator which calculates first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements;
a second complex transfer function calculator which calculates second complex transfer functions during a second period that is not included in the first period by performing linear prediction onto the first complex transfer functions to estimate M×N complex transfer functions in time series;
a living-body component extractor which extracts, using the first complex transfer functions and the second complex transfer functions, a living-body component complex transfer function matrix belonging to a predetermined frequency range corresponding to components affected by one or more vital activities that include at least one of respiration, a heartbeat, or motion of the living body;
a correlation matrix calculator which generates a living-body component complex transfer function vector by re-arranging elements of the living-body component complex transfer function matrix, and calculates a correlation matrix in a frequency direction of the living-body component complex transfer function vector obtained;
a steering vector calculator which calculates a steering vector constituted by elements corresponding respectively to positions of a plurality of regions into which the measurement target region is divided;
a spectrum function calculator which calculates a spectrum function indicating a likelihood that the living body is present, using the correlation matrix and the steering vector; and
a position measurer which outputs a position at which the spectrum function indicates a local maximum value as a position of the living body.

2. A sensor which detects a position of a living body, the sensor comprising:
a transmission antenna which includes N transmission antenna elements, N being a natural number of two or more;
a reception antenna which includes M reception antenna elements, M being a natural number of two or more;
a transmitter which transmits transmission signals to a measurement target region using the N transmission antenna elements;
a receiver which receives M reception signals which have been received respectively by the M reception antenna elements and include reflection signals resulting from the transmission signals transmitted respectively from the N transmission antenna elements being reflected by the living body;
a first complex transfer function calculator which calculates first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements;
a second complex transfer function calculator which calculates second complex transfer functions during a second period that is not included in the first period by performing linear prediction onto the first complex transfer functions to estimate M×N complex transfer functions in time series;
a complex transfer function generator which generates, from the first complex transfer functions and the second complex transfer functions, S third complex transfer functions in mutually different S periods, S being a natural number of two or more;
a living-body component extractor which extracts, using the S third complex transfer functions, a living-body component complex transfer function matrix belonging to a predetermined frequency range corresponding to components affected by one or more vital activities that include at least one of respiration, a heartbeat, or motion of the living body;
a correlation matrix calculator which generates a living-body component complex transfer function vector by re-arranging elements of the living-body component complex transfer function matrix, and calculates a correlation matrix in a frequency direction of the living-body component complex transfer function vector obtained;
a steering vector calculator which calculates S×K extended steering vectors by calculating S steering vectors constituted by elements corresponding respectively to positions of a plurality of regions into which the measurement target region is divided and performing mapping onto each of the S steering vectors, the mapping using a corresponding one of mapping variables, the corresponding one of mapping variables being one of K possible values, K being a natural number of two or more;
a spectrum function calculator which calculates, using the correlation matrix and the S×K extended steering vectors, S×K extended spectrum functions indicating a likelihood that the living body is present using, as variables, the positions of the plurality of regions and the mapping variables;
an individual spectrum combiner which calculates, for each of the K mapping variables, a corresponding one of K combined spectrum functions by combining S extended spectrum functions calculated using the mapping variables as variables among the S×K extended spectrum functions; and
a position measurer which outputs a position at which one of the K combined spectrum functions indicates a local maximum value, and outputs a mapping variable that indicates the local maximum value as a mapping variable of the living body.

3. The sensor according to claim 2,
wherein the mapping variables are discrete K velocities.

4. The sensor according to claim 1,
wherein a length of the first period and a length of the second period are equal to each other.

5. The sensor according to claim 1,
wherein a total length of the first period and the second period is set to a predetermined length according to a type of a vital activity that is a measurement target among the one or more vital activities, and
the predetermined length is a length longer than or equal to a cycle of the vital activity that is the measurement target.

6. The sensor according to claim 1,
wherein the second period is a future period after the first period.

7. The sensor according to claim 1,
wherein the spectrum function calculator calculates a spectrum according to a MUltiple SIgnal Classification (MUSIC) method.

8. The sensor according to claim 1,
wherein the second complex transfer function calculator performs linear prediction using an autoregressive (AR) model.

9. An estimation method that is performed by a sensor,
the sensor including: N transmission antenna elements and M reception antenna elements, N and M each being a natural number of two or more,
the estimation method comprising:
transmitting transmission signals to a measurement target region using the N transmission antenna elements;
receiving M reception signals which have been received respectively by the M reception antenna elements and include reflection signals resulting from the transmission signals transmitted respectively from the N transmission antenna elements being reflected by the living body;
calculating first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements;
calculating second complex transfer functions during a second period that is not included in the first period by performing linear prediction onto the first complex transfer functions to estimate M×N complex transfer functions in time series;
extracting, using the first complex transfer functions and the second complex transfer functions, a living-body component complex transfer function matrix belonging to a predetermined frequency range corresponding to components affected by one or more vital activities that include at least one of respiration, a heartbeat, or motion of the living body;
generating a living-body component complex transfer function vector by re-arranging elements of the living-body component complex transfer function matrix, and calculating a correlation matrix in a frequency direction of the living-body component complex transfer function vector obtained;
calculating a steering vector constituted by elements corresponding respectively to positions of a plurality of regions into which the measurement target region is divided;
calculating a spectrum function indicating a likelihood that the living body is present, using the correlation matrix and the steering vector; and
outputting a position at which the spectrum function indicates a local maximum value as a position of the living body.

10. An estimation method that is performed by a sensor,
the sensor including: N transmission antenna elements and M reception antenna elements, N and M each being a natural number of two or more,
the estimation method comprising:
transmitting transmission signals to a measurement target region using the N transmission antenna elements;
receiving M reception signals which have been received respectively by the M reception antenna elements and include reflection signals resulting from the transmission signals transmitted respectively from the N transmission antenna elements being reflected by the living body;
calculating first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements;
calculating second complex transfer functions during a second period that is not included in the first period by performing linear prediction onto the first complex transfer functions to estimate M×N complex transfer functions in time series;
generating, from the first complex transfer functions and the second complex transfer functions, S third complex transfer functions in mutually different S periods, S being a natural number of two or more;
extracting, using the S third complex transfer functions, a living-body component complex transfer function matrix belonging to a predetermined frequency range corresponding to components affected by one or more vital activities that include at least one of respiration, a heartbeat, or motion of the living body;
generating a living-body component complex transfer function vector by re-arranging elements of the living-body component complex transfer function matrix, and calculating a correlation matrix in a frequency direction of the living-body component complex transfer function vector obtained;
calculating S×K extended steering vectors by calculating S steering vectors constituted by elements corresponding respectively to positions of a plurality of regions into which the measurement target region is divided and performing mapping onto each of the S steering vectors, the mapping using a corresponding one of mapping variables, the corresponding one of mapping variables being one of K possible values, K being a natural number of two or more;
calculating, using the correlation matrix and the S×K extended steering vectors, S×K extended spectrum functions indicating a likelihood that the living body is present using, as variables, the positions of the plurality of regions and the mapping variables;
calculating, for each of the K mapping variables, a corresponding one of K combined spectrum functions by combining S extended spectrum functions calculated using the mapping variables as variables among the S×K extended spectrum functions; and
outputting a position at which one of the K combined spectrum functions indicates a local maximum value, and outputting a mapping variable that indicates the local maximum value as a mapping variable of the living body.

11. A sensor system comprising:
a sensor which detects current positions of a living body; and
a server which sequentially obtains the current positions detected by the sensor from the sensor via a network, and accumulates the current positions obtained sequentially,
wherein the sensor includes:
a transmission antenna which includes N transmission antenna elements, N being a natural number of two or more;
a reception antenna which includes M reception antenna elements, M being a natural number of two or more;
a transmitter which transmits transmission signals to a measurement target region using the N transmission antenna elements;
a receiver which receives M reception signals which have been received respectively by the M reception antenna elements and include reflection signals resulting from the transmission signals transmitted respectively from the N transmission antenna elements being reflected by the living body;
a first complex transfer function calculator which calculates first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements;
a second complex transfer function calculator which calculates second complex transfer functions during a second period that is not included in the first period by performing linear prediction onto the first complex transfer functions to estimate M×N complex transfer functions in time series;
a living-body component extractor which extracts, using the first complex transfer functions and the second complex transfer functions, a living-body component complex transfer function matrix belonging to a predetermined frequency range corresponding to components affected by one or more vital activities that include at least one of respiration, a heartbeat, or motion of the living body;
a correlation matrix calculator which generates a living-body component complex transfer function vector by re-arranging elements of the living-body component complex transfer function matrix, and calculates a correlation matrix in a frequency direction of the living-body component complex transfer function vector obtained;
a steering vector calculator which calculates a steering vector constituted by elements corresponding respectively to positions of a plurality of regions into which the measurement target region is divided;
a spectrum function calculator which calculates a spectrum function indicating a likelihood that the living body is present, using the correlation matrix and the steering vector; and
a position measurer which outputs a position at which the spectrum function indicates a local maximum value as a position of the living body.

12. A sensor system comprising:
a sensor which detects current positions of a living body; and
a server which sequentially obtains the current positions detected by the sensor from the sensor via a network, and accumulates the current positions obtained sequentially,
wherein the sensor is a sensor which identifies the current positions of the living body and includes:
a transmission antenna which includes N transmission antenna elements, N being a natural number of two or more;
a reception antenna which includes M reception antenna elements, M being a natural number of two or more;
a transmitter which transmits transmission signals to a measurement target region using the N transmission antenna elements;
a receiver which receives M reception signals which have been received respectively by the M reception antenna elements and include reflection signals resulting from the transmission signals transmitted respectively from the N transmission antenna elements being reflected by the living body;
a first complex transfer function calculator which calculates first complex transfer functions obtained by recording an M×N complex transfer function matrix in time series during a first period, from the reception signals received respectively by the M reception antenna elements during a predetermined period, the M×N complex transfer function matrix including complex transfer functions as components, the complex transfer functions each indicating characteristics of propagation between a corresponding one of the N transmission antenna elements and a corresponding one of the M reception antenna elements;
a second complex transfer function calculator which calculates second complex transfer functions during a second period that is not included in the first period by performing linear prediction onto the first complex transfer functions to estimate M×N complex transfer functions in time series;
a complex transfer function generator which generates, from the first complex transfer functions and the second complex transfer functions, S third complex transfer functions in mutually different S periods, S being a natural number of two or more;
a living-body component extractor which extracts, using the S third complex transfer functions, a living-body component complex transfer function matrix belonging to a predetermined frequency range corresponding to components affected by one or more vital activities that include at least one of respiration, a heartbeat, or motion of the living body;
a correlation matrix calculator which generates a living-body component complex transfer function vector by re-arranging elements of the living-body component complex transfer function matrix, and calculates a correlation matrix in a frequency direction of the living-body component complex transfer function vector obtained;
a steering vector calculator which calculates S×K extended steering vectors by calculating S steering vectors constituted by elements corresponding respectively to positions of a plurality of regions into which the measurement target region is divided and performing mapping onto each of the S steering vectors, the mapping using a corresponding one of mapping variables, the corresponding one of mapping variables being one of K possible values, K being a natural number of two or more;
a spectrum function calculator which calculates, using the correlation matrix and the S×K extended steering vectors, S×K extended spectrum functions indicating a likelihood that the living body is present using, as variables, the positions of the plurality of regions and the mapping variables;
an individual spectrum combiner which calculates, for each of the K mapping variables, a corresponding one of K combined spectrum functions by combining S extended spectrum functions calculated using the mapping variables as variables among the S×K extended spectrum functions; and
a position measurer which outputs a position at which one of the K combined spectrum functions indicates a local maximum value, and outputs a mapping variable that indicates the local maximum value as a mapping variable of the living body.
